(19) United States
(12) Patent Application Publication
(10) Pub. No.: US 2016/0292760 A1
(43) Pub. Date: Oct. 6, 2016

(54) SYSTEM AND METHOD FOR AUTOMATICALLY GENERATING A ROOFING PLAN WITH COST ESTIMATION

(71) Applicant: James Pastore, Roseville, CA (US)

(72) Inventor: James Pastore, Roseville, CA (US)

(21) Appl. No.: 14/678,787

(22) Filed: Apr. 3, 2015

(51) Int. Cl. G06Q 30/06; G06Q 50/16

(52) U.S. Cl. CPC G06Q 30/0611; G06Q 50/16

(57) ABSTRACT

A system and method for automatically generating a roofing plan with cost estimation are disclosed. A particular embodiment includes: generating, by use of a data processor, a user interface on a client device for prompting a user to enter a plurality of job parameter inputs, the job parameter inputs including a product selection based on product information received from a plurality of product sources; generating, by use of the data processor, a roofing plan with cost estimation based on the job parameter inputs, the roofing plan including elements from the plurality of job parameter inputs and dynamically computed elements; generating a bid that corresponds to the generated roofing plan; and generating a contract that corresponds to the generated roofing plan.

### TECHNICAL FIELD

This patent application relates to computer-implemented software and networked systems, according to one embodiment, and more specifically to a system and method for automatically generating a roofing plan with cost estimation.

### COPYRIGHT

A portion of the disclosure of this patent document contains material that is subject to copyright protection. The copyright owner has no objection to the facsimile reproduction of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2014-2015 James Pastore, All Rights Reserved.

### BACKGROUND

Software programs in various forms for use by general contractors are known in the art. However, current systems are not capable of providing to a potential on-site end user, such as a property owner or local contractor, a complete automated roofing plan including cost estimation, bid generation, and contract generation. As a result, the end user often has little basis upon which to measure the integrity or competence of a local roofing contractor, or to communicate therewith in an informed fashion. The end user also cannot readily make changes to the roofing plan or offer up-sell options to a potential customer.

### BRIEF DESCRIPTION OF THE DRAWINGS

The various embodiments are illustrated by way of example, and not by way of limitation, in the figures of the accompanying drawings in which:

FIG. 1 illustrates an example embodiment of a roofing plan generation system in a network-enabled environment;

FIGS. 2 through 13 illustrate an example embodiment, implemented as a web application (app), that shows the basic elements of the user interface of the example embodiment for job specification input;

FIGS. 14 through 15 illustrate an example embodiment, implemented as a web app, that shows the basic elements of the user interface for presenting an automatically generated bid;

FIGS. 16 through 18 illustrate an example embodiment, implemented as a web app, that shows the basic elements of the user interface for presenting an automatically generated contract;

FIG. 19 is a processing flow chart illustrating an example embodiment of a method as described herein;

FIG. 20 illustrates another example embodiment of a networked system in which various embodiments may operate; and

FIG. 21 shows a diagrammatic representation of machine in the example form of a computer system within which a set of instructions when executed may cause the machine to perform any one or more of the methodologies discussed herein.

### DETAILED DESCRIPTION

In the following description, for purposes of explanation, numerous specific details are set forth in order to provide a thorough understanding of the various embodiments. It will be evident, however, to one of ordinary skill in the art that the various embodiments may be practiced without these specific details.

In the various embodiments described herein, a system and method for automatically generating a roofing plan with cost estimation are disclosed. The various embodiments change the way that roofing plans, bids, and contracts are generated and updated. An example embodiment described herein provides a platform to enable an end user, such as a roofing contractor, to quickly and accurately produce an automated roofing plan with cost estimation, bid generation, and contract generation. The roofing plan can include an automatically-generated bid and contract in which any parameters can be modified thereby causing the entire bid and contract to be automatically updated. Thus, the end user can automatically generate a roofing bid and contract on site that is accurate and complete. Further, the embodiments described herein can automatically populate roofing product options with corresponding specifications and pricing from a variety of different product vendors, manufacturers, or other product sources. The embodiments described herein can automatically obtain product information from the various product sources in real time via a data network. As a result, the example embodiments described herein provide a robust, versatile, and accurate system for producing a roofing plan with cost estimation.

The various embodiments disclosed herein enable a variety of data network-connected product providers or product sources to provide product definition records that describe the roofing products or related product items the product sources can make available, the specifications and pricing associated with the product items, the product category(ies) associated with the product items, and the shipping or availability information associated with the product items. The various embodiments also enable a variety of data network-connected client users to view, select, and navigate through a contextually categorized set of available product items in a contextual arrangement as part of the automatic generation of a roofing plan. The product sources can be manufacturers, vendors, distributors, product aggregators, or the like. The client users can be contractors, customers, builders, architects, designers, inspectors, and other individual or organizational users, such as businesses, institutions, government, or other organizations. The product items typically include roofing products, related materials, and/or tools for installation, maintenance, or repair of structural roofing.

In various example embodiments described herein, the roofing plan generation platform can receive product item information from the product sources via a data network. Various other network resources can also be accessed via the data network to obtain additional product item information, installation information, or information related to the product items received from the product sources. From the product sources, the roofing plan generation platform can receive their product definition records that describe the roofing products or related product items the product sources can make available, the specifications and pricing associated with the product items, the product category(ies) associated with the product items, the shipping or availability information associated with the product items, and other product item information that each product source has available. From the other network resources, the roofing plan generation platform can receive additional product item information or product installation information, such as documents, photos, blueprints, sketches, maps, reviews, ratings, permits, publications, articles, or other related information associated with a particular product item, roofing installation, building, or location. This information can be collectively used to create product item definition records for each product item available from each of a plurality of product sources. The product item definition records can be aggregated across a plurality of product sources and retained in a network-accessible central data repository.

Once the product item definition records are created using the information as described above and the product item definition records are retained in the network-accessible central data repository, the roofing plan generation platform can perform a variety of processing operations on the data. In a first general processing operation, the roofing plan generation platform can prompt the user to provide a plurality of relevant roofing job parameters and selections, which specify the size, shape, coverage, angles, and types of materials to be used for a particular roofing job. This roofing job input is used by the roofing estimation engine to generate the amounts of particular product materials that will be used for the particular job. As part of this process, the user can enter selections from a variety of product options available from the plurality of product sources.

In a second general processing operation, the roofing plan generation platform can activate a roofing estimation engine to generate a complete roofing plan based on the input parameters and selections captured during the job input phase. The roofing estimation engine can execute concurrently with the job input process to dynamically update the roofing plan as input parameters or selections are modified by the user.

In a third general processing operation, the roofing plan generation platform can automatically generate a bid that corresponds to the parameters and selections entered during the job input phase and processed by the roofing estimation engine. The bid includes specific information customized for the particular roofing job based on the input provided by the user. The bid can also include up-sell options for the customer.

In a fourth general processing operation, the roofing plan generation platform can automatically generate a contract that corresponds to the parameters and selections entered during the job input phase and processed by the roofing estimation engine. The contract includes specific provisions customized for the particular roofing job based on the input provided by the user.

As a result of these processing operations, a user can, in real time, automatically generate a bid and contract for a particular roofing job on site. The user can also modify the parameters or selections associated with the job and automatically get an updated bid and contract. In this manner, the user can quickly respond to customer suggestions or provide up-sell options for the customer.

In various example embodiments described in detail herein, a software application program is used to gather, process, and distribute roofing plan information, a related bid and contract, product item information, and product source information, using a computer system, a web appliance, and/or a mobile device. As described in more detail herein, the computer or computing system on which the described embodiments can be implemented can include personal computers (PCs), portable computing devices, laptops, tablet computers, personal digital assistants (PDAs), wearable computing devices, personal communication devices (e.g., cellular telephones, smartphones, or other wireless devices), network computers, set-top boxes, consumer electronic devices, or any other type of computing, data processing, communication, networking, or electronic system.

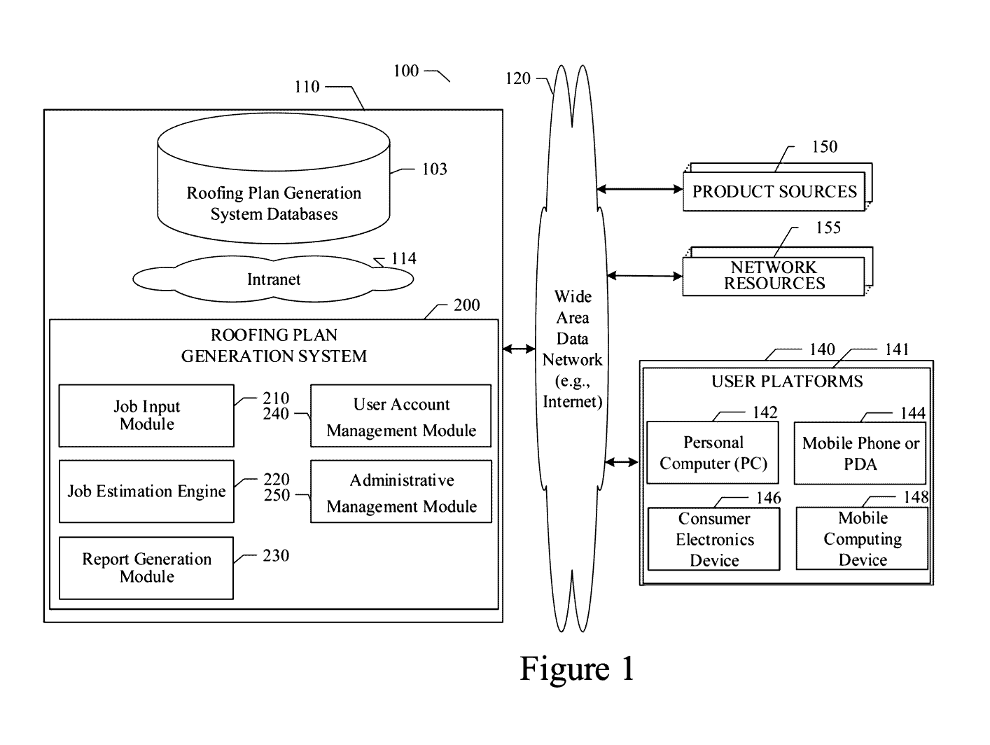

Referring now to FIG. 1, in an example embodiment, a system for automatic roofing plan generation 100 in a network-enabled environment is disclosed. In various example embodiments, an application or service, typically provided by or operating on a host site (e.g., a website) 110, is provided to simplify and facilitate the downloading or hosted use of the roofing plan generation system 200 of an example embodiment. In a particular embodiment, the roofing plan generation system 200, or a portion thereof, can be downloaded from the host site 110 by a user at a user platform 140. Alternatively, the roofing plan generation system 200 can be hosted by the host site 110 for a networked user at a user platform 140. The details of the roofing plan generation system 200 of an example embodiment are provided below.

Referring again to FIG. 1, the roofing plan generation system 200 can be in network communication with a plurality of user platforms 140. The host site 110 and user platforms 140 may communicate and transfer data and information in the data network environment 100 shown in FIG. 1 via wide area data network (e.g., the Internet) 120. Various components of the host site 110 can also communicate internally via a conventional intranet or local area network (LAN) 114.

In an example embodiment, the roofing plan generation system 200 can also be in network communication with a plurality of product sources 150 and a plurality of network resources 155. Product sources 150 can represent the network locations of clients or client computing systems being managed by product sources or client users using an embodiment described herein. For example, in a particular embodiment of the roofing plan generation platform as shown in FIG. 1, product sources 150 can represent the network locations of clients or client computing systems of product manufacturers, vendors, distributors, product aggregators, or the like. Product sources 150 can provide network-transportable information or representations of product items and related product item information. Network resources 155 can represent the network locations of sources of information related to additional product item information or product installation information, such as documents, photos, blueprints, sketches, maps, reviews, ratings, permits, publications, articles, or other related information associated with a particular product item, roofing installation, building, or location, or other related information associated with a particular roofing job of the roofing plan generation system 200 of the example embodiment.

Networks 120 and 114 are configured to couple one computing device with another computing device. Networks 120 and 114 may be enabled to employ any form of computer readable media for communicating information from one electronic device to another. Network 120 can include the Internet in addition to LAN 114, wide area networks (WANs), direct connections, such as through an Ethernet port or a universal serial bus (USB) port, other forms of computer-readable media, or any combination thereof. On an interconnected set of LANs, including those based on differing architectures and protocols, a router and/or gateway device can act as a link between LANs, enabling messages to be sent between computing devices. Also, communication links within LANs may include optical fiber data lines, twisted wire pairs or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), optical fiber, wireless links including satellite links, or other communication links known to those of ordinary skill in the art. Furthermore, remote computers and other related electronic devices can be remotely connected to either LANs or WANs via a wireless link, WiFi, BLUETOOTH, satellite, or modem and temporary telephone link.

Networks 120 and 114 may further include any of a variety of wireless sub-networks that may further overlay stand-alone ad-hoc networks, and the like, to provide an infrastructure-oriented connection. Such sub-networks may include mesh networks, Wireless LAN (WLAN) networks, cellular networks, and the like. Networks 120 and 114 may also include an autonomous system of terminals, gateways, routers, and the like connected by wireless radio links or wireless transceivers. These connectors may be configured to be moved freely and randomly and to organize themselves arbitrarily, such that the topology of networks 120 and 114 may change rapidly and arbitrarily.

Networks 120 and 114 may further employ a plurality of access technologies including 2nd (2G), 2.5, 3rd (3G), 4th (4G) generation radio access for cellular systems, WLAN, Wireless Router (WR) mesh, and the like. Access technologies such as 2G, 3G, 4G, and future access networks may enable wide area coverage for mobile devices, such as one or more of client devices 141, with various degrees of mobility. For example, networks 120 and 114 may enable a radio connection through a radio network access such as Global System for Mobile communication (GSM), General Packet Radio Services (GPRS), Enhanced Data GSM Environment (EDGE), Wideband Code Division Multiple Access (WCDMA), CDMA2000, and the like. Networks 120 and 114 may also be constructed for use with various other wired and wireless communication protocols, including TCP/IP, UDP, SIP, SMS, RTP, WAP, CDMA, TDMA, EDGE, UMTS, GPRS, GSM, UWB, WiFi, WiMax, IEEE 802.11x, and the like. In essence, networks 120 and 114 may include virtually any wired and/or wireless communication mechanisms by which information may travel between one computing device and another computing device, network, and the like. In one embodiment, network 114 may represent a LAN that is configured behind a firewall (not shown), within a business data center, for example.

The roofing plan generation system can be implemented using any form of network transportable digital data. The network transportable digital data can be transported in any of a group of data packet or file formats, protocols, and associated mechanisms usable to enable a host site 110 and a user platform 140 to transfer data over a network 120. In one embodiment, the data format for the user interface can be HyperText Markup Language (HTML). HTML is a common markup language for creating web pages and other information that can be displayed in a web browser. In another embodiment, the data format for the user interface can be Extensible Markup Language (XML). XML is a markup language that defines a set of rules for encoding interfaces or documents in a format that is both human-readable and machine-readable. In another embodiment, a JSON (JAVASCRIPT Object Notation) format can be used to stream the interface product to the various user platform 140 devices. JSON is a text-based open standard designed for human-readable data interchange. The JSON format is often used for serializing and transmitting structured data over a network connection. JSON can be used in an embodiment to transmit data between a server, device, or application, wherein JSON serves as an alternative to XML. The Hypertext Transfer Protocol (HTTP) or secure HTTP (HTTPS) can be used as a network data communication protocol.

In a particular embodiment, a user platform 140 with one or more client devices 141 enables a user to access data and provide data and/or selections for the roofing plan generation system 200 via the host 110 and network 120. Client devices 141 may include virtually any computing device that is configured to send and receive information over a network, such as network 120. Such client devices 141 may include portable devices 144, such as, cellular telephones, smart phones, display pagers, radio frequency (RF) devices, infrared (IR) devices, global positioning devices (GPS), Personal Digital Assistants (PDAs), handheld computers, wearable computers, tablet computers, integrated devices combining one or more of the preceding devices, and the like. Client devices 141 may also include other computing devices, such as personal computers 142, multiprocessor systems, microprocessor-based or programmable consumer electronics, network PC's, and the like. Client devices 141 may also include other processing devices, such as consumer electronic (CE) devices 146 and/or mobile computing devices 148, which are known to those of ordinary skill in the art. As such, client devices 141 may range widely in terms of capabilities and features. For example, a client device configured as a cell phone may have a numeric keypad and a few lines of monochrome LCD display on which only text may be displayed. In another example, a web-enabled client device may have a touch sensitive screen, a stylus, and many lines of color LCD display in which both text and graphics may be displayed. Moreover, the web-enabled client device may include a browser application enabled to receive and to send wireless application protocol messages (WAP), and/or wired application messages, and the like. In one embodiment, the browser application is enabled to employ HyperText Markup Language (HTML), Dynamic HTML, Handheld Device Markup Language (HDML), Wireless Markup Language (WML), WMLScript, JAVASCRIPT, EXtensible HTML (xHTML), Compact HTML (CHTML), and the like, to display and/or send digital information. In other embodiments, mobile devices can be configured with applications (apps) with which the functionality described herein can be implemented.

Client devices 141 may also include at least one client application that is configured to send and receive product data or/or control data from another computing device via a wired or wireless network transmission. The client application may include a capability to provide and receive textual data, graphical data, video data, audio data, and the like. Moreover, client devices 141 may be further configured to communicate and/or receive a message, such as through an email application, a Short Message Service (SMS), direct messaging (e.g., TWITTER), Multimedia Message Service (MMS), instant messaging (IM), internet relay chat (IRC), mIRC, JABBER, Enhanced Messaging Service (EMS), text messaging, Smart Messaging, Over the Air (OTA) messaging, or the like, between another computing device, and the like.

As one option, the roofing plan generation system 200, or a portion thereof, can be downloaded to a user device 141 of user platform 140 and executed locally on a user device 141. The downloading of the roofing plan generation system 200 application (or a portion thereof) can be accomplished using conventional software downloading functionality. As a second option, the roofing plan generation system 200 can be hosted by the host site 110 and executed remotely, from the user's perspective, on host system 110. In one embodiment, the roofing plan generation system 200 can be implemented as a service in a service-oriented architecture (SOA) or in a Software-as-a-Service (SAAS) architecture. In any case, the functionality performed by the roofing plan generation system 200 is as described herein, whether the application is executed locally or remotely, relative to the user.

Referring again to FIG. 1, the host site 110 of an example embodiment is shown to include a roofing plan generation system database 103. The network-accessible central database 103 is used in an example embodiment for data storage of roofing product item representations, information related to product items, product item categories, product sources, client users, product item definition records, bids, contracts, configuration data, scheduling data, reporting data, and the like. Database 103 can be in data communication with the roofing plan generation system 200 directly or via intranet 114. It will be apparent to those of ordinary skill in the art that the database 103 can represent multiple datasets and can be used for the storage of a variety of data in support of the roofing plan generation system 200 of an example embodiment.

Referring again to FIG. 1, host site 110 of an example embodiment is shown to include the roofing plan generation system 200. Roofing plan generation system 200 can include a Job Input Module 210, a Job Estimation Engine 220, a Report Generation Module 230, a User Account Management Module 240, and an Administrative Management Module 250. Each of these modules can be implemented as software components executing within an executable environment of roofing plan generation system 200 operating wholly or in part on host site 110 or user platform 140. Each of these modules of an example embodiment is described in more detail below in connection with the figures provided herein.

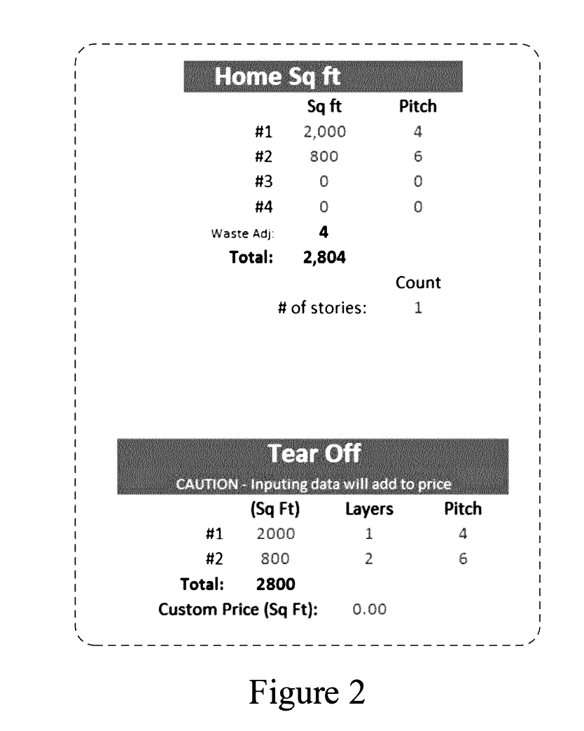

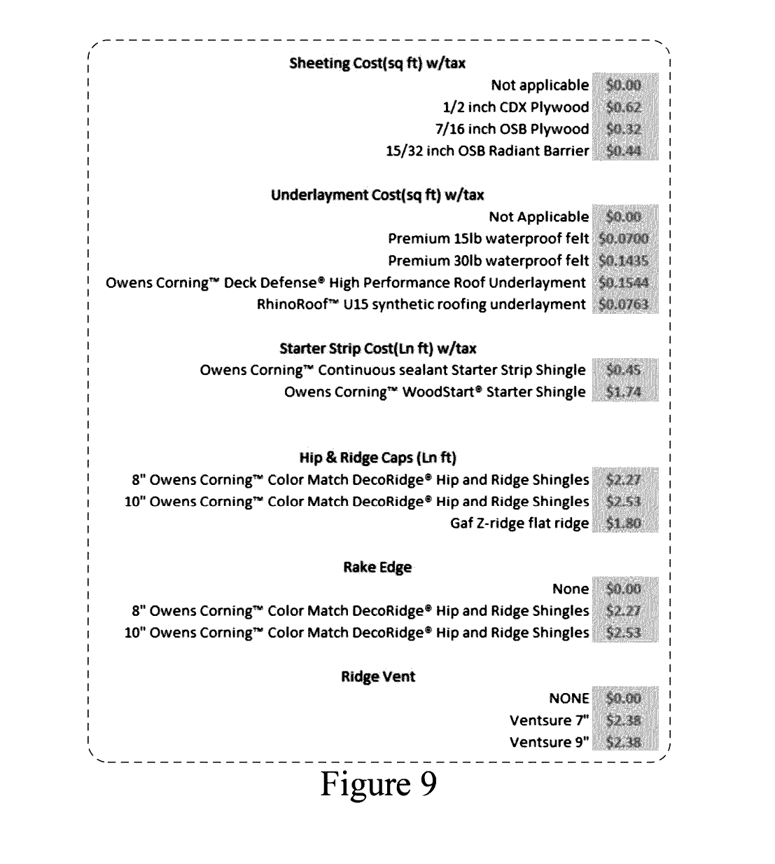

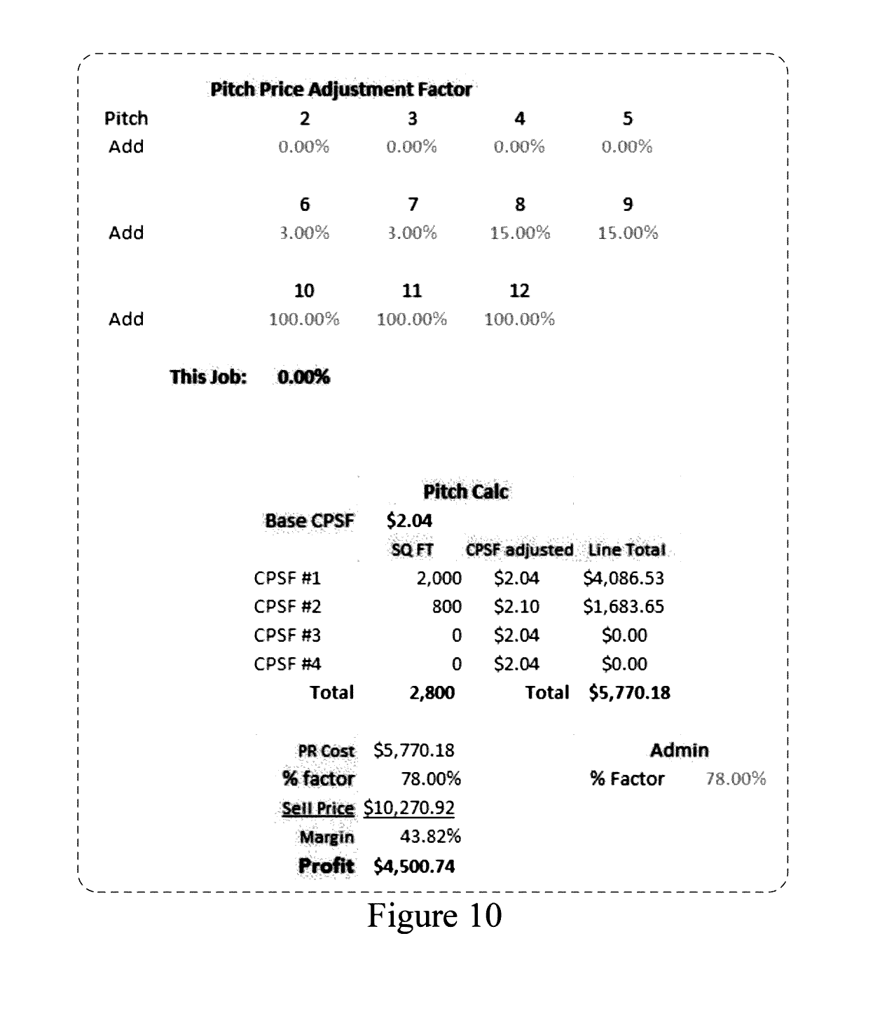

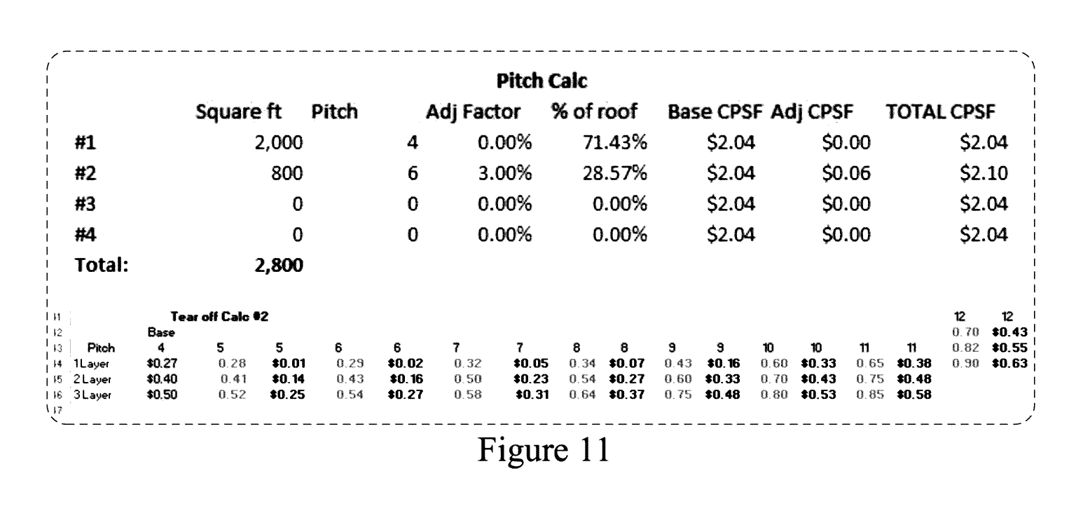

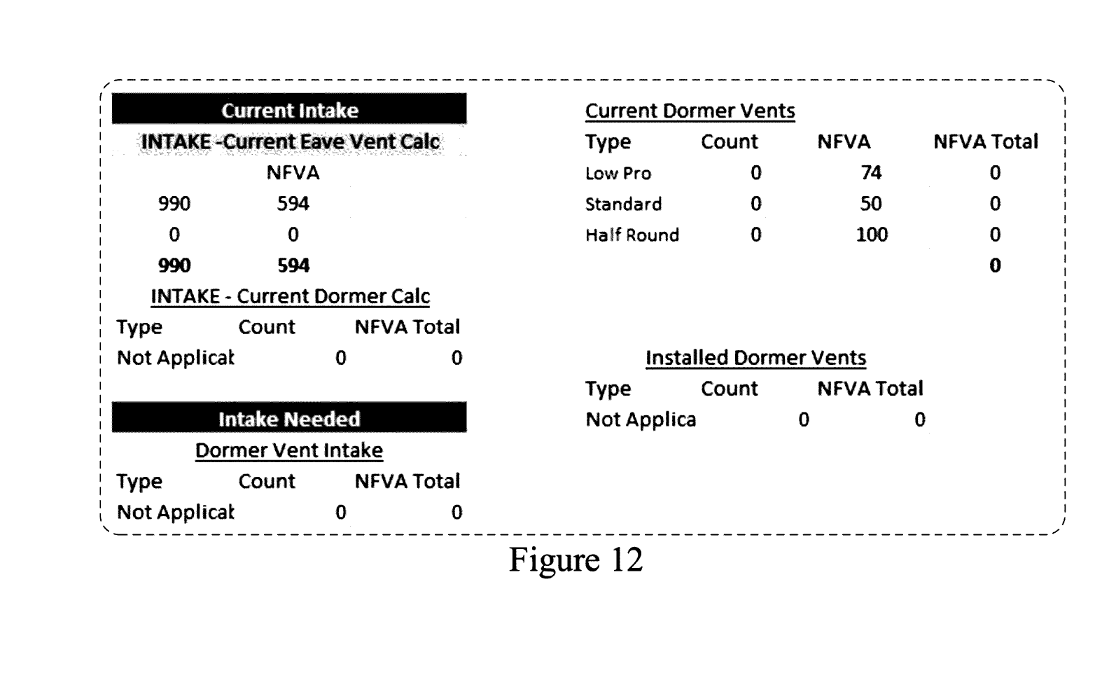

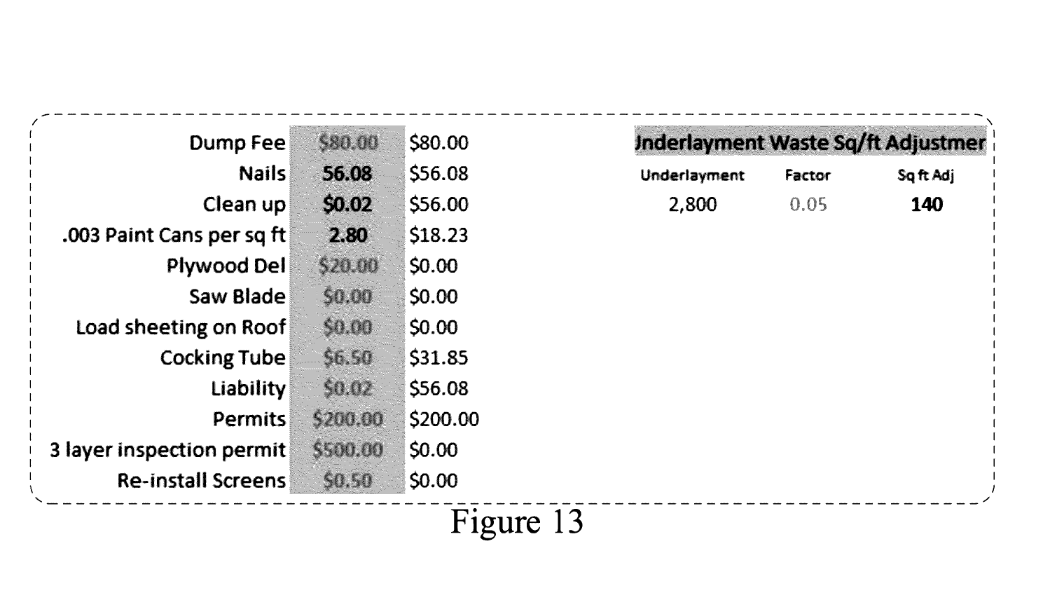

Referring again to FIG. 1, the roofing plan generation system 200 of an example embodiment is shown to include a Job Input Module 210. The Job Input Module 210 is responsible for receiving input from a user or a network-connectible device, the input corresponding to the specifications, parameters, selections, and attributes of a particular roofing job. As described below in more detail in regard to FIGS. 2 through 13, the Job Input Module 210 can generate a user interface on a client device to prompt the user to provide a variety of parameters and selections (roofing job input) that can be used to specify and customize the particular roofing job. As described herein, the client device can be mobile device, such as a smartphone, which can be conveniently used on-site at the construction location. The user can be prompted by the user interface to enter the roofing job input using the data input capabilities of the particular client device, such as alphanumeric or numeric keypad inputs or spoken audio input coupled with a standard voice-to-text conversion module. The standard global positioning satellite (GPS) receiver and/or accelerometer in many portable devices can also be used to obtain measurements or other parameters. Additionally, the camera or other image capture device in many portable devices can be used to take photos of the area under construction at the particular job site. Using conventional technology, software in the portable device can be used to automatically determine measurements, angles, and other information from the photographic images. These automatically determined parameters can also be obtained by the Job Input Module 210 and included as part of the roofing job input.

In an alternative embodiment, the architectural plans or blueprints related to a particular construction job can also be used by the Job Input Module 210 to obtain at least a portion of the roofing job input. For example, architectural plans are often used and re-used to build a plurality of similar structures in different locations (e.g., a residential community or subdivision or commercial office park). These re-used architectural plans are often coded with unique identifiers to enable contractors, planners, and inspectors to pull the appropriate plans for a particular job site. The roofing job input corresponding to a particular set of architectural plans can be pre-determined and associated with the unique identifier of the corresponding architectural plans. Using the pre-determined roofing job input for the architectural plans of a particular job site, the Job Input Module 210 can pre-populate the roofing job input from the pre-determined parameters and selections and thereby save time for the user, who doesn't need to explicitly provide some of the input. Nevertheless, the user can override the pre-populated input.

The example embodiments also improve on the conventional systems by providing real time, detailed, and up-to-date access to a variety of roofing products that can be used for a particular job. Some standard construction estimation tools only list products by generic categories. Other standard systems may list products, but only provide product lists from databases generated years earlier. In many cases, any estimates or construction contracts generated based on the generic or out-of-date product data will be useless. In contrast, the example embodiments described herein provide the data network-connected roofing plan generation system 200, which has instant access to specific, detailed, and up-to-date information on a variety of roofing products from a variety of manufacturers or vendors. As a result, the roofing plan generated by the roofing plan generation system 200 is based on specific product specifications for actual products that are guaranteed to be available and timely shipped from specific product sources in the quantities needed for the particular roofing job. Existing systems cannot provide this level of real time access to product information from multiple product sources and cannot incorporate specific and up-to-date product data into an automated roofing plan.

In support of this real time access to product information, the roofing plan generation system 200 of an example embodiment can be in real time data network communication with a plurality of product sources 150 via network 120 as shown in FIG. 1 and described above. The Job Input Module 210 can use this data network infrastructure to obtain product item information from the plurality of product sources 150. From the product sources 150, the Job Input Module 210 can receive their product item information including product details, specifications, ratings, reviews, compatibilities, pricing, inventory quantities, availability, shipping options, and/or other details that specify the attributes and availability of the various product items that each product source 150 has available. This information can be used to create product item definition records for each product item available from each of a plurality of product sources 150. The product item definition records can be aggregated across a plurality of product sources 150 and locally or remotely retained in a network-accessible central data repository 103. At a pre-determined frequency or on a pre-determined timetable, the Job Input Module 210 can re-visit each product source 150 via network 120 and update the product information stored in the data repository 103. Thereafter, the Job Input Module 210 can present the up-to-date product information to the user via the user interface presented on the client device. For example, the Job Input Module 210 can display contextually arranged product item selections to a client user via any of the user platforms 141 described above. The displayed product item selections are contextually arranged based on prior input provided by the user. For example, the Job Input Module 210 can be configured to suppress the display of a particular product item selection if the product item would not be compatible with the parameters or selections previously provided by the user. As such, the Job Input Module 210 can determine conflicts or incompatibilities between various product options to make sure that incompatible products are not selected for the same job. As such, error detection and correction is automatically provided if incompatible products are selected. Additionally, an example embodiment can link product selections so the user selection of a first product option can automatically cause a corresponding selection of related and linked product options. For example, if Woodmoor™ shingles are selected and this type of shingles requires a specific starter strip installed on eaves and gables, the required starter strip linked with the Woodmoor™ shingles can be automatically selected by the Job Input Module 210 when the Woodmoor™ shingles are selected.

FIGS. 2 through 13 illustrate an example embodiment, implemented as a web application (app), which shows the basic elements of the user interface of the example embodiment for job specification input or other roofing job input. It will be apparent to those of ordinary skill in the art in view of the disclosure herein that a similar user interface can be implemented on other client devices, such as a smartphone, tablet, or other client device. As shown in FIGS. 2 through 13, the user interface can include a set of data input fields, icons, drop down or pull down menus, or other input objects with which the user can provide a variety of parameter and selection inputs. FIGS. 2 through 13 illustrate examples of these parameter and selection inputs in an example embodiment.

Referring now to FIG. 2, a sample user interface illustrates the parameters and other user input collected by the Job Input Module 210. In this case, the user can manipulate the user interface on the client device to specify the square footage and pitch of the particular roofing job. The square footage and pitch can be used by the Job Estimation Engine 220 (described in more detail below) to automatically calculate the roofing squares associated with the job. In an example embodiment, the roofing plan generation system 200 of an example embodiment can support up to four variations of roof pitch. It will be apparent to those of ordinary skill in the art in view of the disclosure herein that additional roof pitch variations can be supported as well. The Job Estimation Engine 220 can also automatically calculate a labor price for the job according to the roof pitch of each section based on the parameters specified by the user. The labor costs can be manually or automatically transferred to the labor and material cost page described in more detail below.

Referring still to FIG. 2, the sample user interface enables the user to manipulate the user interface on the client device to specify the tear off parameters for the job. In particular, the user can enter values corresponding to the square footage of the tear off, the layers, and the pitch. The user interface enables the user to specify the squares to remove and the layers and pitch of those squares. The Job Estimation Engine 220 can automatically calculate or update the labor price based on the specified tear off layers, pitch, and squares removed. The updated labor costs, based on the tear off parameters, can be manually or automatically transferred to the labor and material cost page described in more detail below.

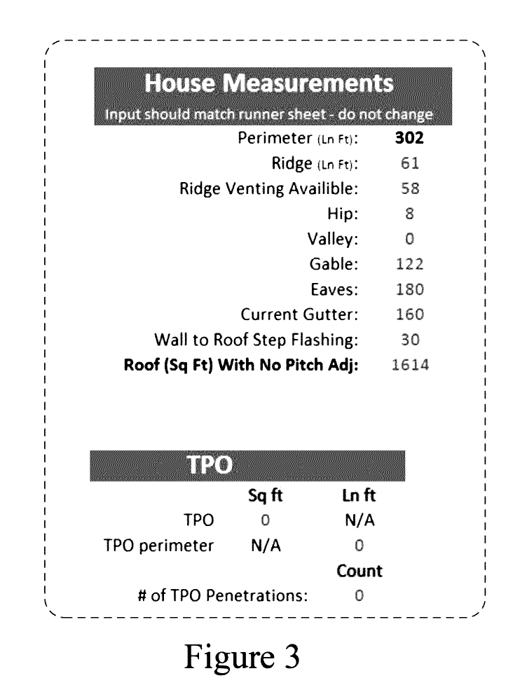

Referring now to FIG. 3, a sample user interface illustrates the parameters and other user input collected by the Job Input Module 210. In this case, the user can manipulate the user interface on the client device to specify the measurement inputs for the particular structure on which the roof construction is taking place. In this example, the user can specify the various measurements of the roof surface under construction, including the perimeter, ridge, venting, hip, valley, eaves, gable, gutter, flashing, and other parameters to define the characteristics of the roof. All specific roof measurements are entered into this section of the user interface.

Referring still to FIG. 3, the sample user interface enables the user to manipulate the user interface on the client device to specify the Thermoplastic Polyolefin (TPO) measurements. As well-known, TPO is a roofing material that can be fully adhered, mechanically fastened, or ballasted to the roof surface. The Job Estimation Engine 220 can automatically calculate TPO cost in conjunction with asphalt roof, for example. TPA roofing is a popular choice for “Green” building as there are no plasticizers added and TPO does not degrade under ultraviolet (UV) radiation.

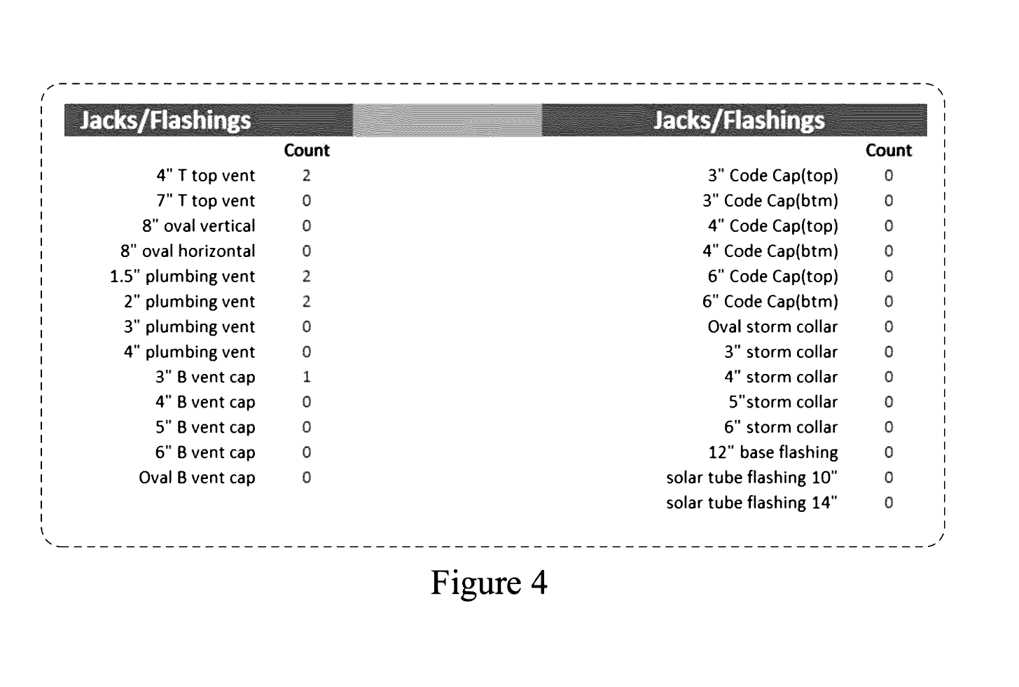

Referring now to FIG. 4, a sample user interface illustrates the parameters and other user input collected by the Job Input Module 210 as related to the jacks and flashings associated with the roofing job. By use of this user interface, the user can specify all jacks and flashings to be replaced. As described above, the real time product information associated with the user-specified jacks and flashings can be automatically obtained from database 103 or directly from a product source 150 via network 120. The obtained real time product information can include the unit prices of the specified materials. The prices per unit can be automatically or manually transferred to the material cost page described in more detail below.

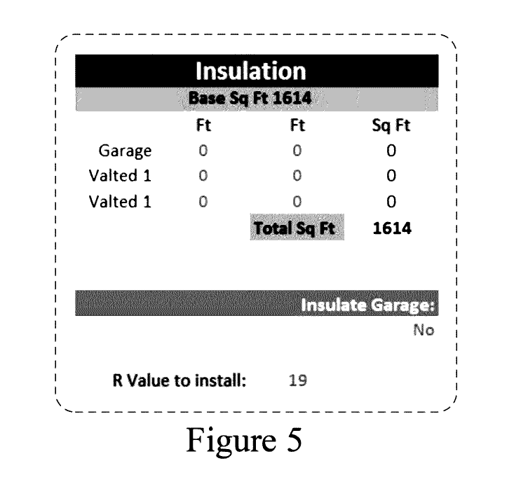

Referring now to FIG. 5, a sample user interface illustrates the parameters and other user input collected by the Job Input Module 210 as related to the insulation associated with the roofing job. By use of this user interface, the user can specify the measurements and other parameters associated with the insulation to be used or installed for the specific job. In particular, the user can specify the measurements and other parameters associated with portions of the structure, such as the garage and vaulted ceiling along with the R-value (thermal resistance) rating of the insulation to install. As described above, the real time product information associated with the user-specified insulation can be automatically obtained from database 103 or directly from a product source 150 via network 120. The obtained real time product information can include the unit prices of the specified materials. The prices per unit can be automatically or manually transferred to the material cost page described in more detail below. The Job Estimation Engine 220 can add or subtract a value from the total structure square footage to calculate total square feet and depth (R-Value) of insulation coverage needed. This automatic computation can include labor costs and job travel time.

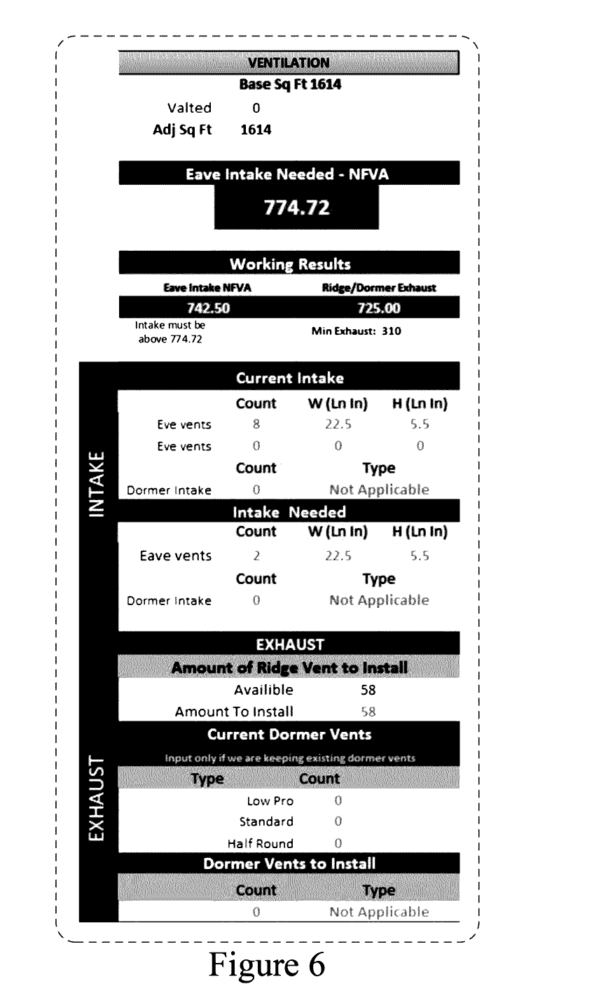

Referring now to FIG. 6, a sample user interface illustrates the parameters and other user input collected by the Job Input Module 210 as related to the Net Free Ventilation Airflow (NFVA) associated with the particular job. The user can input current eave vent size and quantity. The Job Estimation Engine 220 can use this input to automatically calculate by State code the minimum NFVA allowed by law for the State or jurisdiction in which the structure is located. The user can input the size and number of additional vents needed to meet the automatically calculated NFVA requirements. The Job Estimation Engine 220 can notify the user via the user interface if improper ventilation parameters are entered.

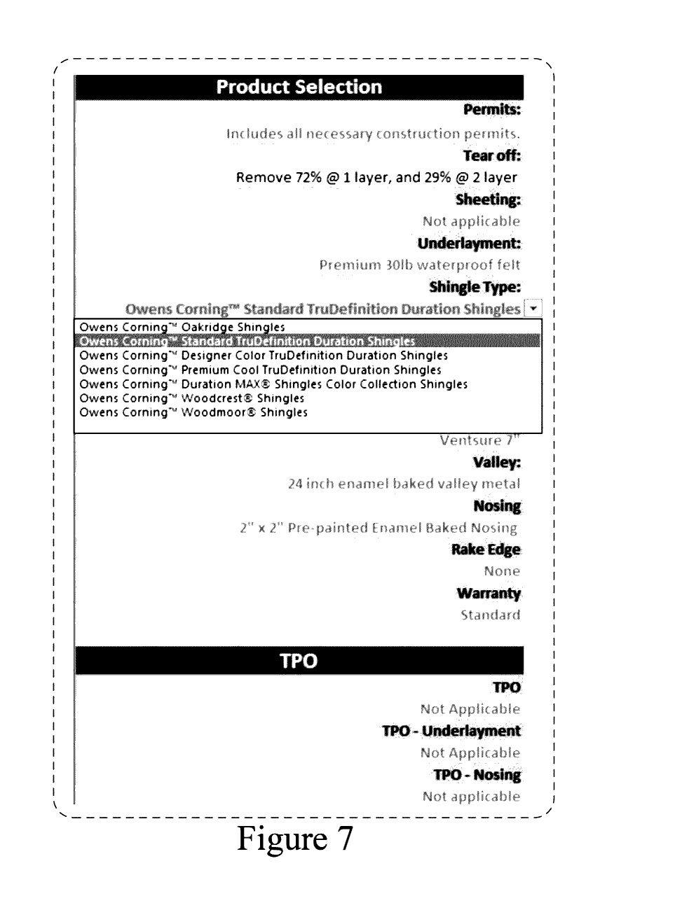

Referring now to FIG. 7, a sample user interface illustrates the parameters and other user input collected by the Job Input Module 210 as related to the user selection of roofing materials or products for the specific job. As described above, the real time product information associated with the user-specified products can be automatically obtained from database 103 or directly from a product source 150 via network 120. Additionally, because the example embodiment is context driven, only the available and compatible products are offered for selection by the user via a drop down or pull down selection region of the user interface. As shown in the example of FIG. 7, the user can select any of the offered specific, compatible, and available roofing products offered by one or more product sources 150. The selected products and corresponding prices per unit can be automatically or manually transferred to the material cost page described in more detail below.

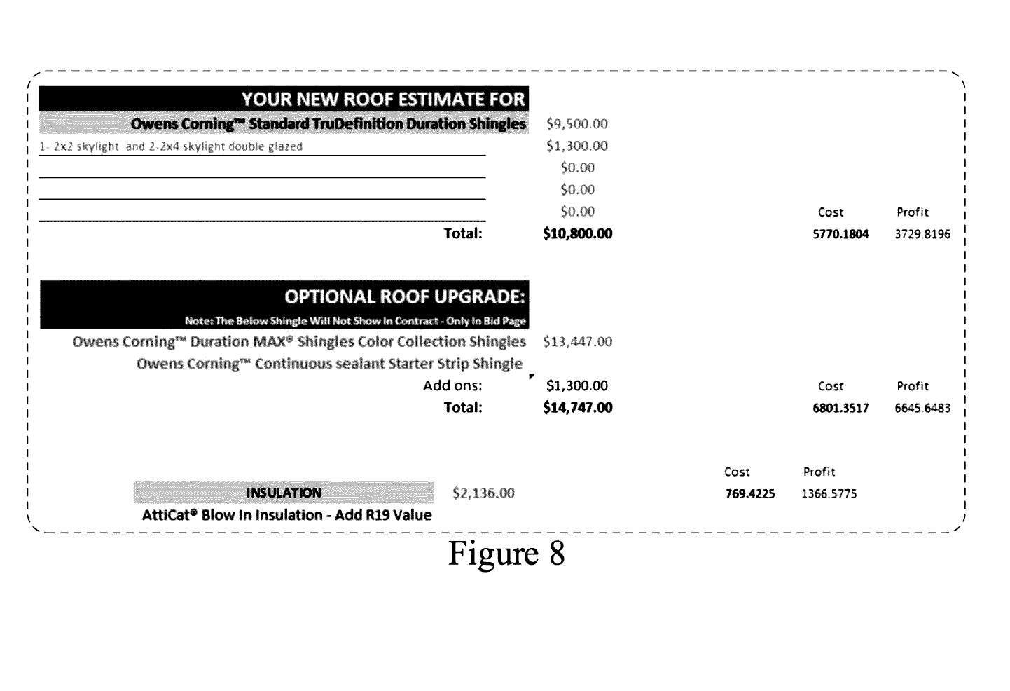

Referring again to FIG. 1, the roofing plan generation system 200 of an example embodiment is shown to include a Job Estimation Engine 220. The Job Estimation Engine 220 is responsible for automatically processing the input received from a user or a network-connectible device via the Job Input Module 210, the received input corresponding to the roofing job input provided by a client user via any of the user interface platforms 141 described above. FIGS. 8 through 13 illustrate an example embodiment, implemented as a web application (app), which shows the basic elements of the user interface of the example embodiment for displaying job specification parameters, selections, or details as provided by the user or automatically calculated by the Job Estimation Engine 220. It will be apparent to those of ordinary skill in the art in view of the disclosure herein that a similar user interface can be implemented on other client devices, such as a smartphone, tablet, or other client device.

As shown in FIGS. 8 through 13, the Job Estimation Engine 220 can use the data obtained by the Job Input Module 210, as described above, to generate a complete roofing plan including specifications and costing for the job based on the input provided by the user and the product selections available from the product sources 150. The job information generated and displayed by the Job Estimation Engine 220 reveals the net cost of the job using the particular user-selected products and materials. The user may also input information associated with any additional items (e.g., skylights, solar panels, etc.) or labor costs. Additionally, the user (e.g., a contractor) can manipulate the user interface to specify the amount they wish to charge the customer for completion of the roofing job. The Job Estimation Engine 220 can compile the collected and automatically generated information to produce a roofing plan for the job that includes cost estimation. FIGS. 8 through 13 illustrate components of the roofing plan generated by the Job Estimation Engine 220 of an example embodiment. Elements of the generated roofing plan can be replicated as part of the automatically-generated job bid or estimate and the related contract. A sample automatically generated bid and contract in an example embodiment are described in more detail below.

Referring again to FIG. 8, the roofing plan generation system 200 of an example embodiment offers the additional feature of providing up-sell options for the customer. Up-sell options are additional features, enhancements, product alternatives, or other variations of the original bid that entice the customer to pay a somewhat higher price in exchange for the additional features. Because the roofing plan generation system 200 is highly automated and dynamic, the originally-entered parameters and selections for a particular job can be readily modified and the resulting changes to the roofing plan can be readily viewed. As a result, the customer or the contractor can quickly see the effects of an alternative product choice or parameter modification. This feature of the example embodiment can be used to up-sell the customer and offer a higher level of product or service options with corresponding pricing as produced by the Job Estimation Engine 220. In a typical scenario, the user inputs the desired upgrade option and the Job Estimation Engine 220 can automatically calculate and display the cost of the upgrade with no addition data change. Additionally, the roofing plan generation system 200 can be configured to automatically offer up-sell options depending on the selection of a particular product item. The roofing plan generation system 200 can also be configured to automatically offer discounts, coupons, rebates, or other customer incentives or loyalty features based on particular selections made during the generation of the roofing plan. Further, an example embodiment provides the ability to offer branded products that are specific to one featured manufacturer.

The Job Estimation Engine 220 can also use the data obtained by the Job Input Module 210, as described above, to generate a complete insulation bid as part of the job. The insulation bid can include specifications and costing for the installation of insulation as part of the job based on the input provided by the user and the product selections available from the product sources 150. The insulation bid information generated and displayed by the Job Estimation Engine 220 reveals the net cost of the insulation bid using the particular user-selected products and materials. The user can add a portion to the bid for contractor labor or services. The insulation add-on price will appear on the bid and the contract, if desired.

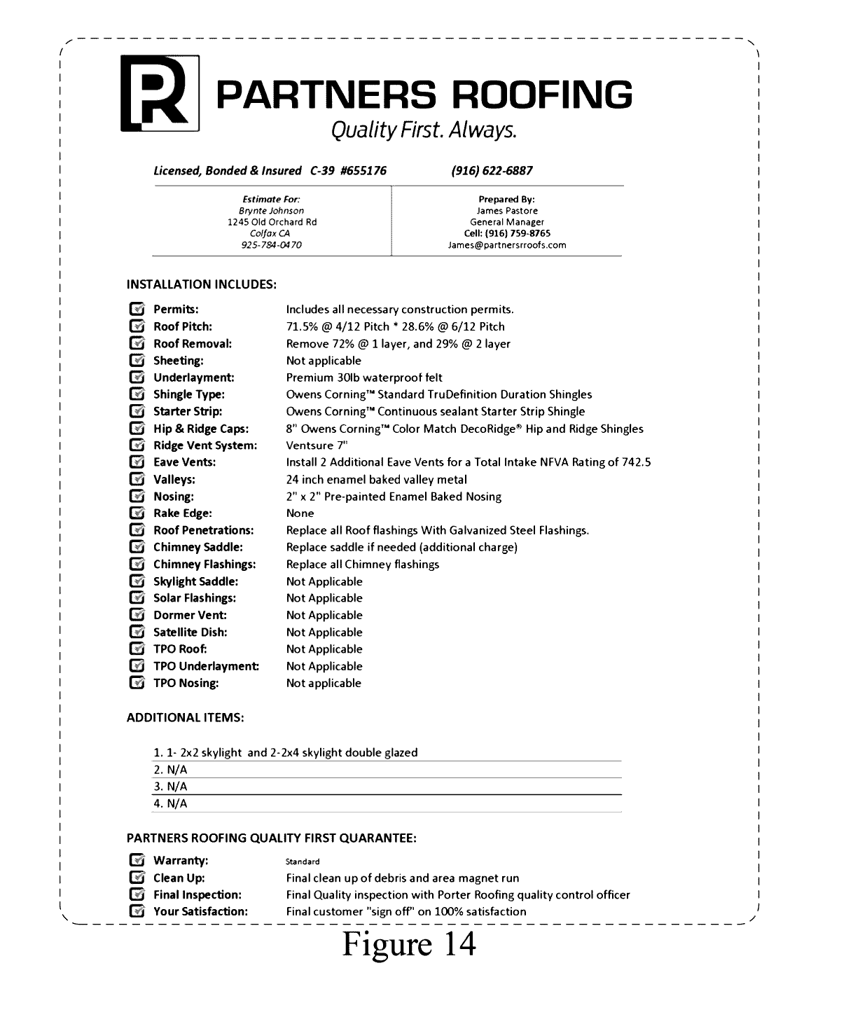

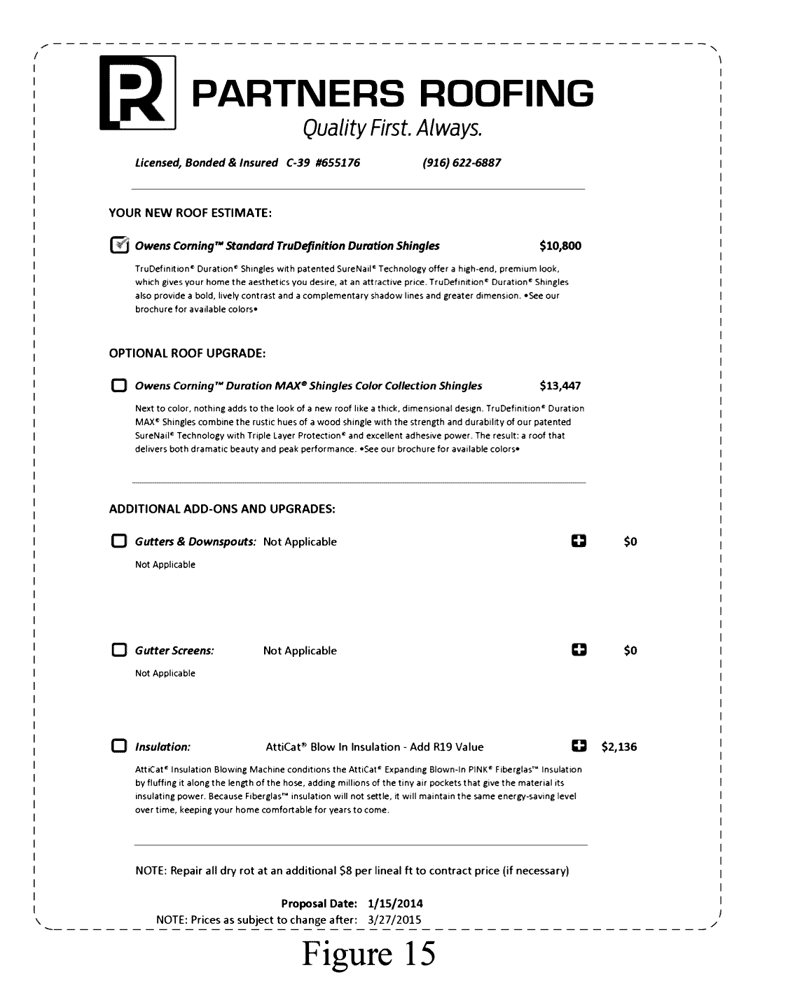

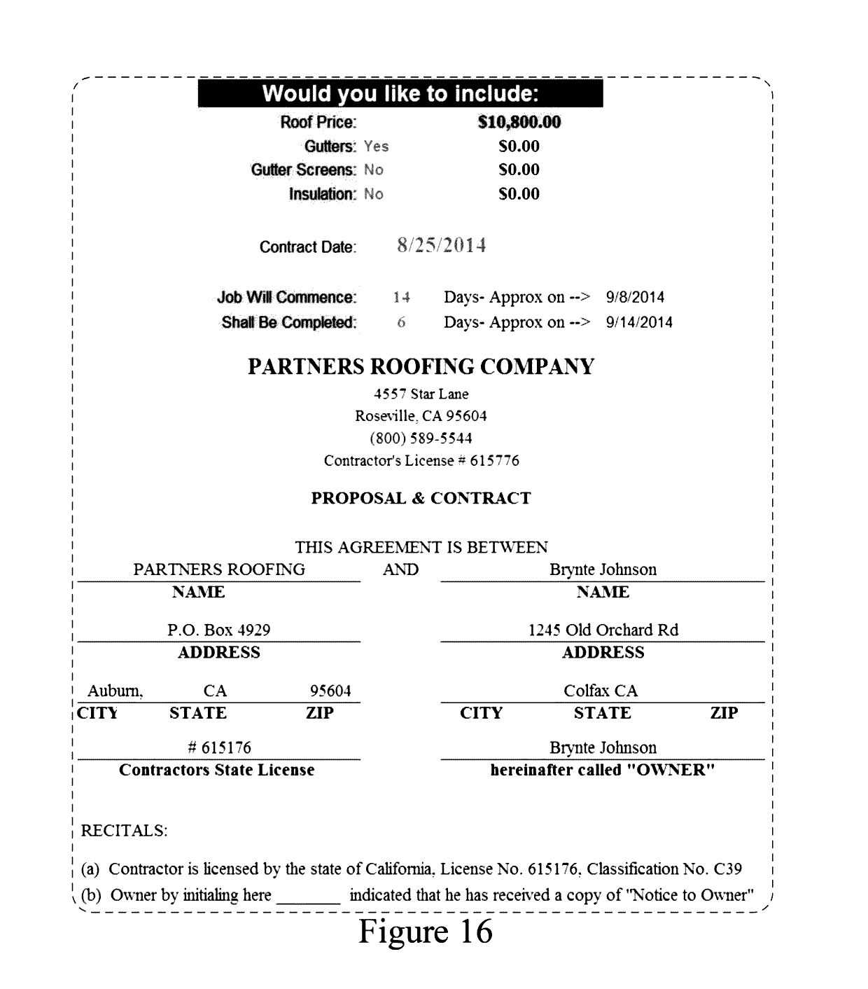

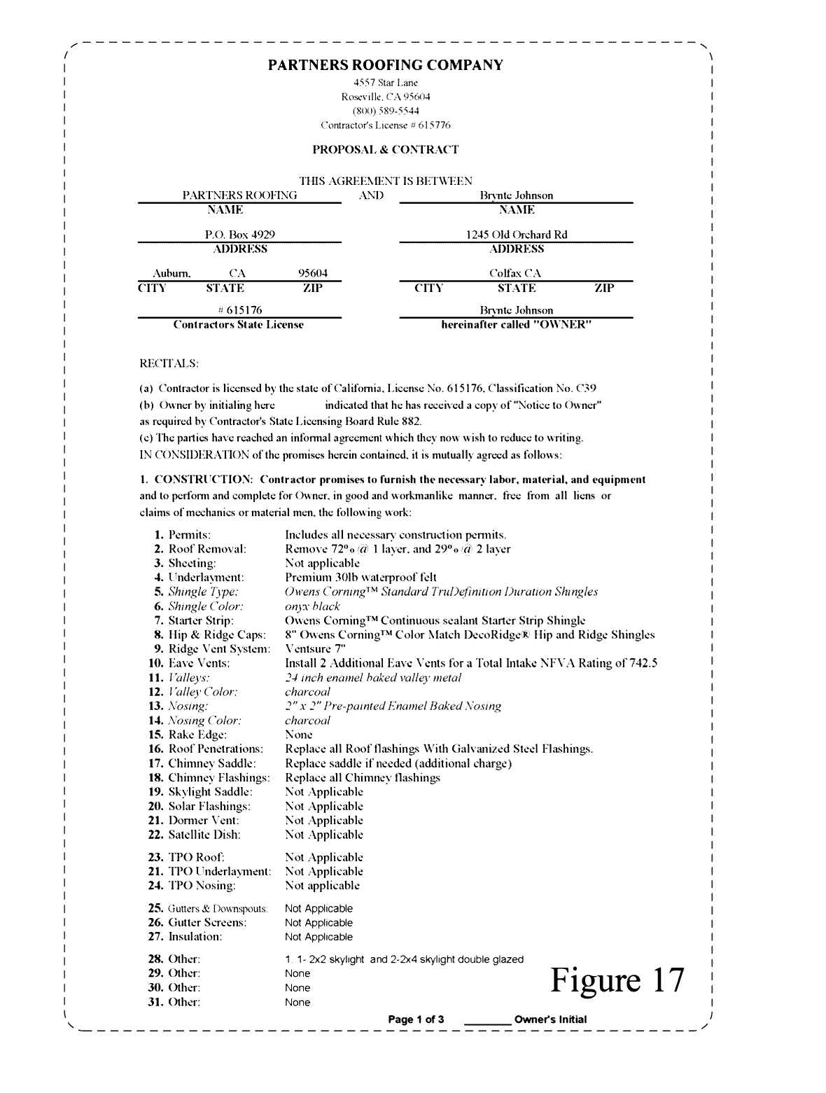

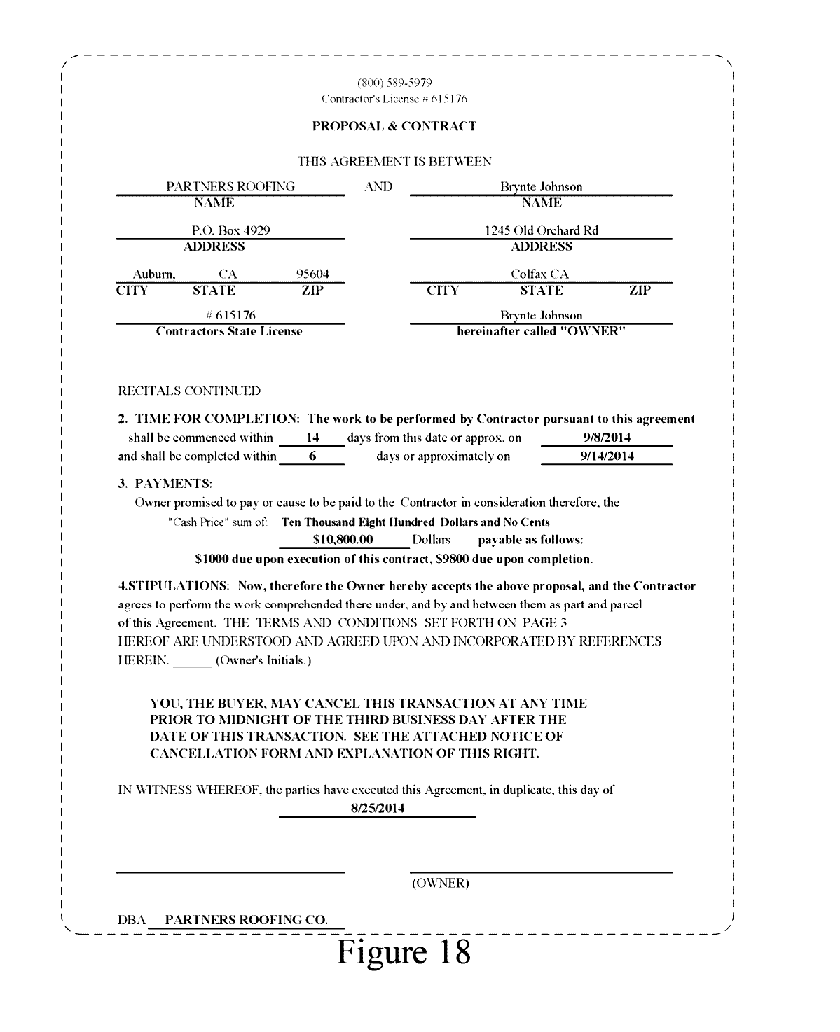

Referring again to FIG. 1, the roofing plan generation system 200 of an example embodiment is shown to include a Report Generation Module 230. The Report Generation Module 230 is responsible for generating bids and contracts based on the roofing plan automatically generated by the Job Estimation Engine 220 as described above. A sample bid in an example embodiment is shown in FIGS. 14 and 15. A sample contract in an example embodiment is shown in FIGS. 16 through 18.

Referring now to FIGS. 14 and 15, a sample bid produced by an example embodiment, implemented as a web app, shows the basic elements of the user interface for presenting an automatically generated bid. The bid is automatically configured to include all of the information, supporting documentation, metrics, and analytics necessary to comply with all applicable parameters and specifications as entered and determined by the Job Input Module 210 and the Job Estimation Engine 220 as described above. As a result, all supporting documentation can be automatically generated. The presentation of the bid is completely automated and requires no extra information. In the example embodiment, the automatically generated bid can reflect the materials used (or proposed), the specified or determined roof pitch and roof removal percentages. The automatically generated bid can further display the roofing job estimate along with a description that is specific to that particular roofing job and roof. The automatically generated bid can further display roof upgrade selections or other up-sell options. For example, the bid can display optional add-ons, such as insulation or product upgrades. The automatically generated bid can further display the proposal date and bid expiration date. The bid content automatically changes as different parameters are entered or different product options are selected.

Referring now to FIGS. 16 through 18, a sample contract produced by an example embodiment, implemented as a web app, shows the basic elements of the user interface for presenting an automatically generated contract. The contract is automatically configured to include all of the information, supporting documentation, metrics, and analytics necessary to comply with all applicable parameters and specifications as entered and determined by the Job Input Module 210 and the Job Estimation Engine 220 as described above. As a result, all supporting documentation can be automatically generated. The presentation of the contract is completely automated and requires no extra information.

Referring again to FIG. 1 and as described above, a user platform 141 can include a mobile device on which a mobile application (app) can be executed. An example embodiment, implemented as a mobile device app, can be used to support a mobile device user interface for the roofing plan generation system 200 of an example embodiment. It will be apparent to those of ordinary skill in the art that other embodiments can also be implemented as a web application (app) with one or more webpages or other types of user interfaces. A mobile version of an example embodiment provides a user-friendly interface from which the user can easily view the relevant client information from a mobile device. As described in more detail herein, a mobile software application (app) embodying a mobile version of an example embodiment as described herein can be installed and executed on a mobile device, such as a smart phone, laptop computer, tablet device, or the like. In an example embodiment, a splash screen appears whenever the user opens or launches the mobile application on the mobile device. This splash screen can display a host logo and wallpaper image while opening the login screen or a live feed of processed client information.

User log-in functionality in the web application or the mobile app provides a user-friendly user interface in which the user can provide identifying information (e.g., an email address and password) associated with the user account. If the user does not have an account, the user can create an account from this user interface. The process of creating a user account in an example embodiment only requires the user to provide the identifying information (e.g., name, surname, e-mail address, and password). By completing this information, the user can create an account and get access to processed client information.

Referring again to FIG. 1, the roofing plan generation system 200 of an example embodiment is also shown to include a user account management module 240. The user account management module 240 can be used to create and maintain a user account on the host site 110. The user account management module 240 can also be used to configure user settings, create and maintain a user/user profile on host site 110, and otherwise manage user data and operational parameters on host site 110. In the example embodiment described herein, a user can register as an identified user in order to share product item information, bids, contracts, job information, postings, documents, communications, or other information. The registered user can enter their identifying information during a log-in phase and thereafter can share product item information, bids, contracts, job information, postings, documents, communications, or other information.

Referring again to FIG. 1, the roofing plan generation system 200 of an example embodiment is shown to include an administrative management module 250. The administrative management module 250 can be used by an agent or administrator of the roofing plan generation system 200 to manage user accounts, configure system features, and to manage the roofing plan generation system 200. The administrative management module 250 can also be used to enforce privacy protections and product controls for users. Moreover, the administrative management module 250 can also be used to generate and/or process a variety of analytics associated with the operation of the roofing plan generation system 200. For example, the administrative management module 250 can generate various statistical models that represent the activity of the community of users and related product sources, client users, agents, affiliates, and the like. These analytics can be shared, licensed, or sold to others.

Although the various user interface displays provided by the example embodiments described herein are nearly infinitely varied, the descriptions of the user interface displays and sequences are provided herein to describe various features of the disclosed embodiments. These user interface displays and sequences are described herein with reference to example embodiments. It will be apparent to those of ordinary skill in the art in view of the disclosure herein that equivalent user interface displays and sequences can be implemented within the scope of the inventive subject matter disclosed and claimed herein.

In a particular example embodiment, a sequence of operations using an example embodiment described herein to process a roofing job is provided below.

### Step 1—Set Up

The user (e.g., a contractor) can cause the Job Input Module 210 to obtain all product information from a plurality of product sources. The product information can be automatically downloaded from the manufacturers or databases via network 120. Alternatively or in addition, the user can explicitly specify the product information for a specific roofing job. The product information can include the product specifications, cost of purchase, availability, shipping details, etc. Once the product input is obtained or provided, the user does not need to change the product data unless the product information at the product source changes.
   Examples—current cost of plywood $8.02 per sheet
   Current cost of Owens Corning™ Tru Color Shingles $40 a bundle
   Current cost of Owens Corning™ Sure protect Underlayment $50 a roll—etc. . . .
The user (e.g., a contractor) can input labor cost
   Labor Cost to install one square of shingles
   Labor cost to install on sheet of plywood
   Labor Cost to remove one layer of existing shingles per square—etc. . . .
The user (e.g., a contractor or salesman) can measure the roof
   All dimensions
      Number of squares
      Ridge
      Hip Valley
      # of jacks flashing on roof
      # of Chimneys
      Number of ridge Vents etc. . . .
   The roof measurements can be input into a phone and then automatically transferred to the Job Input Module 210.

### Step 2—Input Page

The user (e.g., a contractor or salesman) can enter the roofing job input using the Job Input Module 210

### Step 3

The user (e.g., a contractor or salesman) can select product options with or without the customer
   Brand or type of underlayment
   Brand or type of shingle
   Color of shingle
   Amount attic insulation desired
The Job Estimation Engine 220 can:
   Display all products available with pull downs
   Display errors if incompatible combination of products are selected
   Determine if incorrect NFVA ventilation is present. If incorrect NFVA ventilation is present, additional vents and/or venting ridge can be input in order to remove error codes

### Step 4

The Job Estimation Engine 220 can display the real time contractor cost for roofing job. If any parameter or selection in the roofing plan is changed, the plan and price will immediately change in a corresponding manner

### Step 5

The user (e.g., a contractor or salesman) can enter the price they would like to charge for the particular roofing job based on the cost displayed (e.g., complete product and labor net)
Additional items may be added—e.g., random repairs or special requests (e.g., skylights, fixing rotting wood, etc.)
Optional roof upgrades or up-sell options
   Pull down can allow contractor/salesman to input an upgraded shingle option that will also be displayed with a net price in real time.
   Based on this net cost, the contractor/salesman may enter a desired amount to charge the customer
Optional insulation add on
   The Job Estimation Engine 220 can display the net cost depending on the R-value selected (e.g., the amount or depth on insulation wanted)
   Based on this net cost, the contractor/salesman may enter a desired amount to charge customer
      Step 6—Bid Page automatically designed for the customer
The Report Generation Module 230 can provide a one click option to print/PDF an automatically-generated bid for the particular job
The Report Generation Module 230 can print out a custom branded bid page that includes all selections specific to that customer. No extra input is required on the bid page
   Displayed in dynamic fashion—Example
      Customer name and address
      Salespersons name and contact info
      71.5% @ 4/12 Pitch*28.6% @ 6/12 Pitch
      Owens Corning™ Standard TruDefinition Duration Shingles
      Install 2 Additional Eave Vents for a Total Intake NFVA Rating of 742.5
      Etc. . . .
      New roof estimate—with cost inputted into input page
         Dynamically changing full feature description depending on product displayed
         Calculated lowest monthly finance payment is calculated and can be displayed
      Optional roof upgrade—with cost inputted into input page
         Dynamically changing full feature description depending on product displayed
         Calculated lowest monthly finance payment is calculated and can be displayed
      Optional insulation—with cost inputted into input page
         Dynamically changing full feature description depending on product displayed
            Step 7—Contract page automatically designed for customer
The Report Generation Module 230 can provide a one click option to print/PDF an automatically-generated contract for the particular job
Includes sale dynamic information as above
Automatically fills in names/dates/price etc. . . .
No extra input is required on contract page—its ready to print and sign

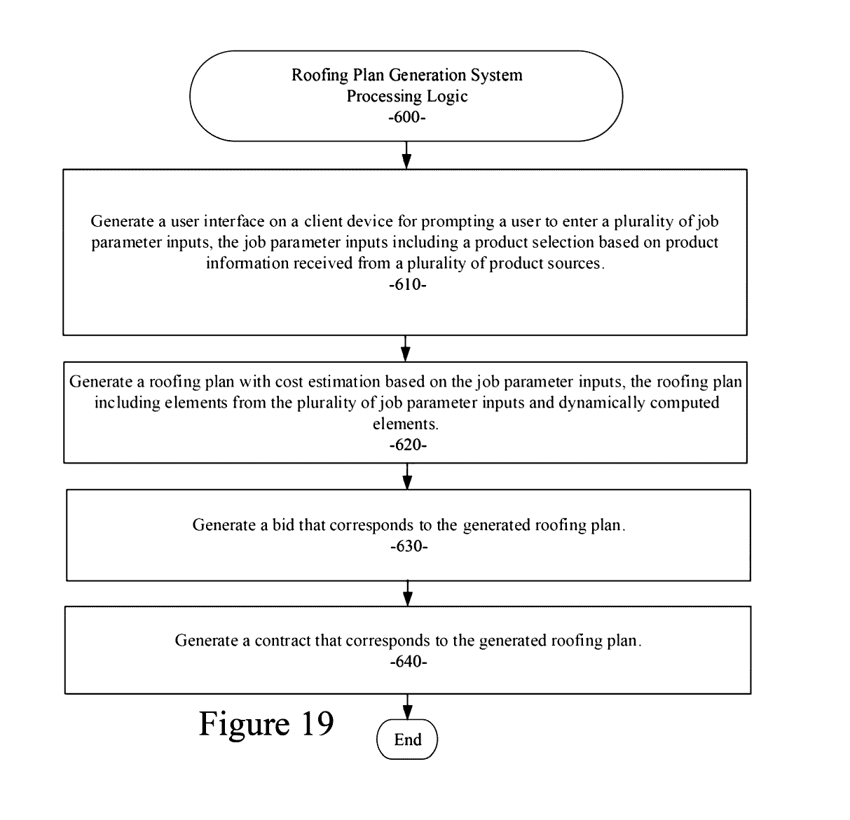

Referring now to FIG. 19, a processing flow diagram illustrates an example embodiment of the data processing performed by the roofing plan generation system 200 as described herein. The method 600 of an example embodiment includes: generating, by use of a data processor, a user interface on a client device for prompting a user to enter a plurality of job parameter inputs, the job parameter inputs including a product selection based on product information received from a plurality of product sources (processing block 610); generating, by use of the data processor, a roofing plan with cost estimation based on the job parameter inputs, the roofing plan including elements from the plurality of job parameter inputs and dynamically computed elements (processing block 620); generating a bid that corresponds to the generated roofing plan (processing block 630); and generating a contract that corresponds to the generated roofing plan (processing block 640).

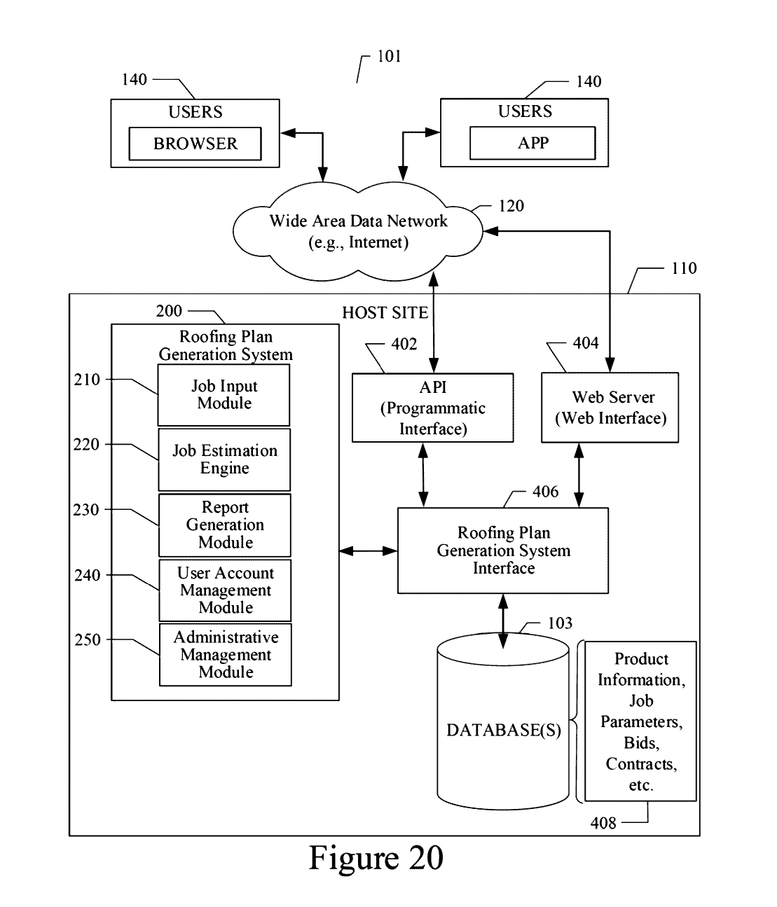

Referring now to FIG. 20, another example embodiment 101 of a networked system in which various embodiments may operate is illustrated. In the embodiment illustrated, the host site 110 is shown to include the roofing plan generation system 200. The roofing plan generation system 200 is shown to include the functional components 210 through 250, as described above. In a particular embodiment, the host site 110 may also include a web server 404, having a web interface with which users may interact with the host site 110 via a user interface or web interface. The host site 110 may also include an application programming interface (API) 402 with which the host site 110 may interact with other network entities on a programmatic or automated data transfer level. The API 402 and web interface 404 may be configured to interact with the roofing plan generation system 200 either directly or via an interface 406. The roofing plan generation system 200 may be configured to access a data storage device 103 and data 408 therein either directly or via the interface 406.

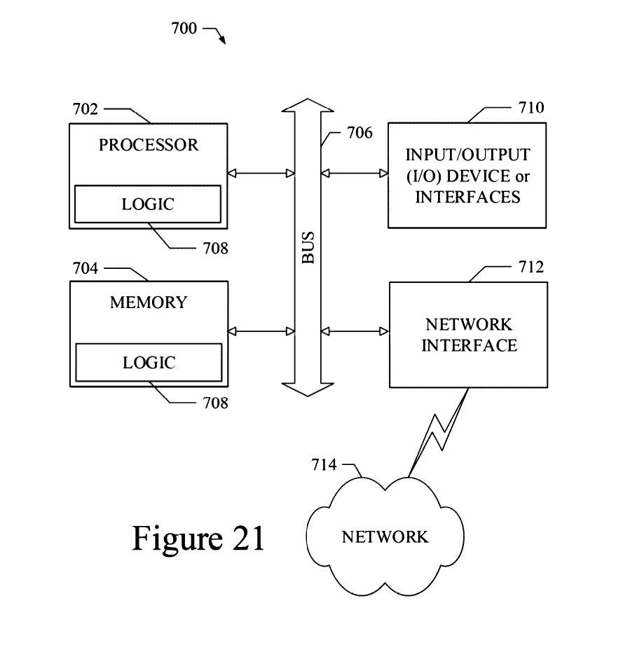

FIG. 21 shows a diagrammatic representation of a machine in the example form of a stationary or mobile computing and/or communication system 700 within which a set of instructions when executed and/or processing logic when activated may cause the machine to perform any one or more of the methodologies described and/or claimed herein. In alternative embodiments, the machine may operate as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a laptop computer, a tablet computing system, a Personal Digital Assistant (PDA), a cellular telephone, a smartphone, a web appliance, a set-top box (STB), a network router, switch or bridge, or any machine capable of executing a set of instructions (sequential or otherwise) or activating processing logic that specify actions to be taken by that machine. Further, while only a single machine is illustrated, the term “machine” can also be taken to include any collection of machines that individually or jointly execute a set (or multiple sets) of instructions or processing logic to perform any one or more of the methodologies described and/or claimed herein.

The example stationary or mobile computing and/or communication system 700 includes a data processor 702 (e.g., a System-on-a-Chip (SoC), general processing core, graphics core, and optionally other processing logic) and a memory 704, which can communicate with each other via a bus or other data transfer system 706. The stationary or mobile computing and/or communication system 700 may further include various input/output (I/O) devices and/or interfaces 710, such as a monitor, touchscreen display, keyboard or keypad, cursor control device, voice interface, and optionally a network interface 712. In an example embodiment, the network interface 712 can include one or more network interface devices or radio transceivers configured for compatibility with any one or more standard wired network data communication protocols, wireless and/or cellular protocols or access technologies (e.g., 2nd (2G), 2.5, 3rd (3G), 4th (4G) generation, and future generation radio access for cellular systems, Global System for Mobile communication (GSM), General Packet Radio Services (GPRS), Enhanced Data GSM Environment (EDGE), Wideband Code Division Multiple Access (WCDMA), LTE, CDMA2000, WLAN, Wireless Router (WR) mesh, and the like). Network interface 712 may also be configured for use with various other wired and/or wireless communication protocols, including TCP/IP, UDP, SIP, SMS, RTP, WAP, CDMA, TDMA, UMTS, UWB, WiFi, WiMax, BLUETOOTH, IEEE 802.11x, and the like. In essence, network interface 712 may include or support virtually any wired and/or wireless communication mechanisms by which information may travel between the stationary or mobile computing and/or communication system 700 and another computing or communication system via network 714.

The memory 704 can represent a machine-readable medium on which is stored one or more sets of instructions, software, firmware, or other processing logic (e.g., logic 708) embodying any one or more of the methodologies or functions described and/or claimed herein. The logic 708, or a portion thereof, may also reside, completely or at least partially within the processor 702 during execution thereof by the stationary or mobile computing and/or communication system 700. As such, the memory 704 and the processor 702 may also constitute machine-readable media. The logic 708, or a portion thereof, may also be configured as processing logic or logic, at least a portion of which is partially implemented in hardware. The logic 708, or a portion thereof, may further be transmitted or received over a network 714 via the network interface 712. While the machine-readable medium of an example embodiment can be a single medium, the term “machine-readable medium” should be taken to include a single non-transitory medium or multiple non-transitory media (e.g., a centralized or distributed database, and/or associated caches and computing systems) that store the one or more sets of instructions. The term “machine-readable medium” can also be taken to include any non-transitory medium that is capable of storing, encoding or carrying a set of instructions for execution by the machine and that cause the machine to perform any one or more of the methodologies of the various embodiments, or that is capable of storing, encoding or carrying data structures utilized by or associated with such a set of instructions. The term “machine-readable medium” can accordingly be taken to include, but not be limited to, solid-state memories, optical media, and magnetic media.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method for automated roofing plan generation with cost estimation, the method comprising:
generating, by use of a data processor, a user interface on a client device for prompting a user to enter a plurality of job parameter inputs, the job parameter inputs including a product selection based on product information received from a plurality of product sources;
generating, by use of the data processor, a rooting plan with cost estimation based on the job parameter inputs, the roofing plan including elements from the plurality of job parameter inputs and dynamically computed elements;
generating a bid that corresponds to the generated roofing plan; and
generating a contract that corresponds to the generated roofing plan.

2. The method of claim 1 wherein information related to a plurality of product items is obtained from the plurality of product sources via a data network.

3. The method of claim 1 wherein the user interface enabling the user to select among a plurality of product items.

4. The method of claim 1 wherein the plurality of job parameter inputs includes structure square footage, roof measurements, and roof characteristics including, ridge, venting, hip, valley, eaves, gable, gutter, and flashing characteristics.

5. The method of claim 1 wherein the plurality of job parameter inputs includes Thermoplastic Polyolefin (TPO) measurements.

6. The method of claim 1 wherein the plurality of job parameter inputs includes measurements and other parameters associated with insulation to be used for a particular job.

7. The method of claim 1 including automatically calculating minimum Net Free Ventilation Airflow (NFVA) allowed by law for the jurisdiction in which a particular job is located.

8. The method of claim 1 including automatically offering up-sell options depending on a selection of a particular product item.

9. The method of claim 1 wherein the client device is of a type from the group consisting of: a personal computer (PC), a laptop computer, a tablet computing system, a Personal Digital Assistant (PDA), a cellular telephone, a smartphone, and a web appliance.

10. A system comprising:
a data processor;
a network interface, in data communication with the data processor, for communication on a data network; and
a roofing plan generation system, executable by the data processor, to:
generate a user interface on a client device for prompting a user to enter a plurality of job parameter inputs, the job parameter inputs including, a product selection based on product information received from a plurality of product sources;
generate a roofing plan with cost estimation based on the job parameter inputs, the roofing plan including elements from the plurality of job parameter inputs and dynamically computed elements;
generate a bid that corresponds to the generated roofing plan; and
generate a contract that corresponds to the generated roofing plan.

11. The system of claim 10 wherein information related to a plurality of product items is obtained from the plurality of product sources via the data network.

12. The system of claim 10 wherein the user interface to enable the user to select among a plurality of product items.

13. The system of claim 10 wherein the plurality of job parameter inputs includes structure square footage, roof measurements, and roof characteristics including, ridge, venting, hip, valley, eaves, gable, gutter, and flashing characteristics.

14. The system of claim 10 wherein the plurality of job parameter inputs includes measurements and other parameters associated with insulation to be used for a particular job.

15. The system of claim 10 wherein the roofing plan generation system to automatically calculate minimum Net Free Ventilation Airflow (NFVA) allowed by law for the jurisdiction in which a particular job is located.

16. The system of claim 10 wherein the roofing plan generation system to automatically offer up-sell options depending on a selection of a particular product item.

17. The system of claim 10 wherein the client device is of a type from the group consisting of: a personal computer (PC), a laptop computer, a tablet computing system, a Personal Digital Assistant (PDA), a cellular telephone, a smartphone, and a web appliance.

18. A non-transitory machine-useable storage medium embodying instructions which, when executed by a machine, cause the machine to:
generate a user interface on a client device for prompting a user to enter a plurality of job parameter inputs, the job parameter inputs including a product selection based on product information received from a plurality of product sources;
generate a roofing plan with cost estimation based on the job parameter inputs; the roofing plan including elements from the plurality of job parameter inputs and dynamically computed elements;
generate a bid that corresponds to the generated roofing plan; and
generate a contract that corresponds to the generated roofing plan.

19. The machine-useable storage medium of claim 18 wherein information related to a plurality of product items is obtained from the plurality of product sources via the data network.

20. The machine-useable storage medium of claim 18 wherein the user interface is to enable the user to select among a plurality of product items.
